(19) United States
(12) Patent Application Publication
(10) Pub. No.: US 2009/0086311 A1
(43) Pub. Date: Apr. 2, 2009

(54) Spectral Filtering Method and Apparatus in Optical Parametric Chirped Pulse Amplification

(75) Inventors: Christophe Dorrer, Rochester, NY (US); Andrey Okishev, Penfield, NY (US); IIdar Begishev, Fairport, NY (US); Jonathan Zuegel, Rochester, NY (US)

Correspondence Address: BOND, SCHOENECK & KING, PLLC, 10 BROWN ROAD, SUITE 201, ITHACA, NY, 14850-1248, US

(73) Assignee: University of Rochester, Rochester, NY (US)

(21) Appl. No.: 12/184,543

(22) Filed: Aug. 1, 2008

Related U.S. Application Data
(60) Provisional application No. 60/953,490, filed on Aug. 2, 2007.

(51) Int. Cl. H01S 3/00

(52) U.S. Cl. 359/337.2

(57) ABSTRACT

Method and apparatus embodiments of the invention are directed to mitigating temporal contrast degradation in optical parametric chirped pulse amplification (OPCPA) laser systems. A spectral filter is used in an OPCPA laser system to remove or reduce of out-of-band amplified spontaneous emission (ASE) from an amplified pump pulse and/or the longitudinal modes of a seed laser used to generate the pump pulse, which typically cause detrimental temporal intensity fluctuations in the amplified pump signal. According to an illustrative embodiment, a volume Bragg grating (VBG) filter element is disposed in the pump regenerative amplifier cavity where the pump pulse undergoes multiple passes on the filter element.

### RELATED APPLICATION DATA

This application claims priority to U.S. Provisional application Ser. No. 60/953,490 filed on Aug. 2, 2007, the subject matter of which is incorporated by reference herein in its entirety.

### FEDERALLY SPONSORED RESEARCH

Embodiments of the invention were made with government support under Cooperative Agreement No. DE-FC52-92SF19460 awarded by the U.S. Department of Energy Office of Inertial Confinement Fusion. The government may have certain rights in the invention.

### BACKGROUND OF THE INVENTION

1. Field of the Invention

Embodiments of the invention generally relate to Optical Parametric Chirped Pulse Amplification (OPCPA)-based laser systems. Embodiments of the invention are particularly directed to apparatus and methods directed to improving the temporal contrast of OPCPA systems and architectures utilizing OPCPA. More particularly, embodiments of the invention are directed to spectral filtering of amplified spontaneous emission (ASE) present on the pump pulses of OPCPA systems.

2. Brief Discussion of Related Art

The phenomenon of temporal contrast degradation in a signal pulse can result in significant performance issues in laser systems and their applications that utilize optical parametric chirped pulse amplification (OPCPA) and OPCPA architectures. For example, temporal contrast degradation is highly detrimental to the effective interaction of high-energy short pulses with matter. The temporal contrast of the pulse is generally defined as the ratio of the pulse peak intensity to the maximum intensity in a given temporal range before the main pulse. Thus temporal contrast is an important parameter since the light intensity before the peak of a high-intensity pulse can be sufficient to interact with a target.

OPCPA is an effective technique to amplify broadband high-energy pulses in stand-alone systems or as the front end of large-scale laser facilities. Parametric amplification is an instantaneous process with a direct transfer of the temporal intensity of the pump onto the temporal intensity of the signal. As a result of the amplification process, the temporal contrast of OPCPA systems can be significantly degraded by temporal noise on the pump pulse spectrally modulating the stretched pulse being amplified. The temporal intensity fluctuations of the pump typically arise from amplified spontaneous emission (ASE) generated during the amplification of the high-energy pump pulse, or may also be due, for example, to the longitudinal modes of a seed laser used to generate the pump.

It would be advantageous to provide apparatus and methods for improving the temporal contrast of OPCPA systems and architectures utilizing OPCPA.

### SUMMARY

An embodiment of the invention is directed to a method of mitigating temporal contrast degradation in an OPCPA laser system that includes spectrally filtering a pump pulse during amplification of the pump pulse.

An embodiment of the invention is directed to an OPCPA laser system that includes an amplified optical pump pulse and a filter to spectrally filter out-of-band ASE from the amplified optical pump pulse. According to a particularly advantageous, non-limiting aspect, the filter is a volume Bragg grating (VBG) that is disposed in a regenerative amplifier cavity used to amplify the pump pulse of the OPCPA system.

According to various, non-limiting, exemplary aspects, the filter type and/or filter process may include one or more of the following:
wherein the filter is a Fiber Bragg grating (FBG) and the pump pulse is spectrally filtered during its generation and pulse carving in a fiber front end. This may be advantageous if part of the front end is fiber coupled;
wherein the filter is a Fabry-Perot etalon that is disposed in a laser cavity or amplifier cavity, or is arranged to propagate a single-pass of the pump pulse through the Fabry-Perot etalon;
wherein the filter comprises dielectric mirrors (i.e. stacks of materials of different optical index) optimized to provide a narrowband reflectivity, which can be used either in a single-pass configuration or as one of the mirrors of a laser or amplifier cavity;
wherein the filter comprises dielectric filters optimized to provide a narrowband transmission, which may be used in a single-pass configuration or in a laser or amplifier cavity;
wherein the filter comprises dispersion-based filters, where a dispersing element spatially disperses the optical frequency components of the pump pulse so that appropriate spatial filtering leads to spectral filtering. These filters may be implemented in a free-space configuration or in fiber-coupled setups. Examples of dispersing elements include diffraction gratings, prisms, virtually-imaged phase arrays (VIPAs), array waveguide gratings (AWGs), and others known in the art. Examples of spatial filters for such application include an open slit cut in a blocking material, and spatial light modulators (for example, those based on liquid crystals or mirrors);
wherein the filter comprises a dispersing element placed in a cavity, which reduces the bandwidth of the generated or amplified pump pulse by sending unwanted spectral components in directions where amplification is not as efficient as for a user-defined spectral component (for example, the optical frequency corresponding to the user-defined pump).

In non-limiting terms, the filters and/or filtering processes referred to above function to limit the spectral content of the pump output to remove unwanted temporal intensity variations. According to an illustrative aspect, the filter should be narrow enough to remove the high-frequency components of the pump pulse corresponding to ASE, but should be broad enough to preserve the temporal shape of the pump pulse. In an exemplary aspect in which the pump pulse is a super-Gaussian pulse with sharp leading and trailing edges to optimize the temporal overlap between pump and signal in the nonlinear OPCPA crystals, the filter should be broad enough to preserve the sharp leading and trailing edges. An important property of the filter is the shape of its transmission as a function of the optical frequency after a single pass or multiple passes on the filter (in the case of a regenerative amplifier architecture). Some unwanted intensity fluctuations might be present due to practical considerations such as amplified spontaneous emission generated during the amplification process, or longitudinal modes of a seed laser used to generate the pump pulse. The purpose of the filter is to remove the spectral features that correspond to these unwanted components (or at least reduce their intensity), while preserving the spectral features corresponding to the user-defined pump pulse. In particular, the bandwidth of the filter is important, and how the spectral transmission varies away from the peak of the transmission. The filter choice may depend on the bandwidth of the pump pulse that is required by the user to pump the OPCPA system and the bandwidth that needs to be filtered (as set, for example, by the bandwidth of the ASE generated during the amplification of the pump pulse, which is related to the bandwidth of the amplification materials, or by the spacing of longitudinal modes in the seed laser used to generate the pump pulse).

According to a non-limiting exemplary embodiment of the invention, an OPCPA system comprises at least one optical amplifier including a volume Bragg grating (VBG) upon which an amplified (or being amplified) pump pulse makes one or multiple passes. According to an aspect, the at least one amplifier is a regenerative amplifier that comprises a VBG as one reflector of its cavity.

A non-limiting exemplary embodiment of the invention is directed to a method of obtaining a narrowband amplified optical pump pulse using a VBG in an optical amplifier to selectively and repetitively spectrally filter the pump pulse.

### BRIEF DESCRIPTION OF THE DRAWINGS

FIG. 1 shows a schematic of an OPCPA system in accordance with an illustrative embodiment of the invention;

FIG. 2 shows a schematic optical layout of a diode-pumped regenerative amplifier (DPRA) of the OCPCA system of FIG. 1, according to a non-limiting, exemplary embodiment of the invention;

FIG. 3a shows an exemplary Gaussian filter function 301 with a 230-pm FWHM one-pass bandwidth and a filter function 302 with an effective bandwidth of 23 pm FWHM simulated after 100 round trips in the DPRA of FIG. 2; FIG. 3b shows a simulation of a super-Gaussian signal pulse 304 before (solid line) and after (dotted markers) bandwidth narrowing using a 23-pm FWHM filter, according to a non-limiting exemplary embodiment of the invention;

FIG. 4 shows plots of the optical spectrum 403 of the unseeded DPRA measured with a mirror in the cavity and with a VBG in the cavity (curve 404), and the optical spectrum 405 of the signal amplified by the DPRA as measured with an optical spectrum analyzer, according to an illustrative embodiment of the invention;

FIG. 5(a) is a plot showing the third-order scanning cross correlation of the OPCPA output pulse when only the preamplifier is running at saturation, and, 5(b) when only the preamplifier is running at half its nominal output power, where the continuous curve represents the results obtained with a mirror in the DPRA and the dashed curve represents the results obtained with a VBG in the DPRA, according to a non-limiting illustrative aspect of the invention;

FIG. 6(a) is a plot showing the third-order scanning cross correlation of the OPCPA output pulse when the average power of the monochromatic laser of the IFES is (a) 10 mW, and, FIG. 6(b) 0.1 mW, where the continuous curve represents the results obtained with a mirror in the DPRA and the dashed curve represents the results obtained with a VBG in the DPRA, according to a non-limiting illustrative aspect of the invention; and

FIG. 7a shows a detector image of the measured beam profile of the DPRA with an intracavity VBG; FIG. 7(b) are graphs that show a comparison of the temporal intensity of the pump pulse used to pump the OPCPA system with and without a VBG in DPRA, according to an illustrative aspect of the invention.

### DETAILED DESCRIPTION OF EMBODIMENTS OF THE INVENTION

In the field of laser-matter interaction, extremely high-power lasers play an important role. The beam intensity on a target has increased due to progress in terms of pulse duration, energy, and focal-spot size. The temporal contrast of the pulse thus becomes extremely important, since the light intensity before the peak of a high-intensity pulse can be sufficient to interact with a target. Detrimental modifications of a solid target via preplasma formation have been reported at intensities as low as 10⁸ W/cm². Since intensities of the order of 10²² W/cm² have been reached, temporal intensity-contrast monitoring and improvement have become a critical issue.

In OPCPA systems, induced variations of the spectral density of the amplified signal can have a significant effect on the contrast of the recompressed pulse. For a stretched signal with second-order dispersion φ, the temporal pedestal at time t induced by a pump with ASE spectrum I_{ASE} essentially depends on I_{ASE}(t/φ)+I_{ASE}(−t/φ). A major source of contrast degradation of laser systems is the fluorescence generated in the high-gain front end of the system. The pump-induced contrast degradation is not directly linked to the gain, and the contrast of a high-contrast front end followed by an OPCPA system could be significantly degraded.

Embodiments of the invention are directed to methods and apparatus used to improve the temporal contrast of OPCPA systems by spectrally filtering the pump pulse. According to a non-limiting, particularly advantageous aspect illustrated below, simple and efficient filtering of the pump pulse is performed in a regenerative amplifier using a volume Bragg grating (VBG), where the bandwidth of the filtering is narrowed significantly by the large number of round trips in the cavity.

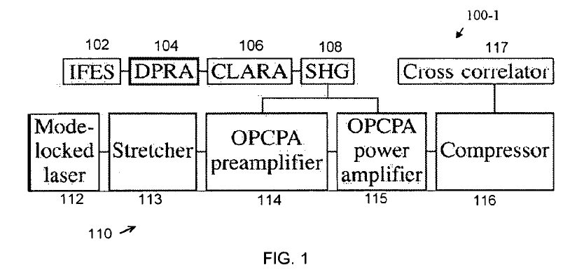

FIG. 1 is a schematic 100-1 of the MultiTerawatt Laser System at the University of Rochester Laboratory for Laser Energetics (Rochester, N.Y.). Contrast improvement by regenerative spectral filtering was performed on the front end of the laser system. The pump pulse is generated by a fiber integrated front end source (IFES) 102, where a 2.4 ns pulse at approximately 1053 nm is temporally shaped to precompensate the square pulse distortion during amplification. This pulse is amplified at 5 Hz from 100 pJ to 4 mJ in a diode-pumped regenerative amplifier (DPRA) 104.

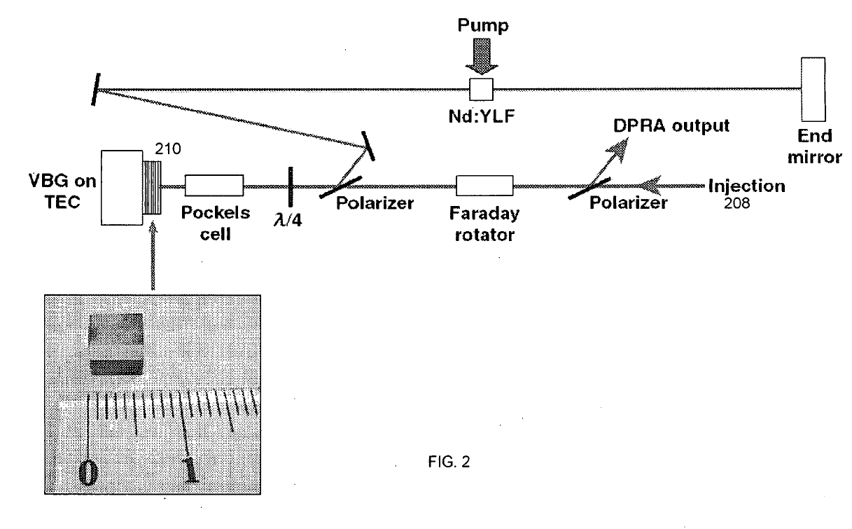

A schematic optical layout of the DPRA is illustrated in FIG. 2. As illustrated in FIG. 2, one of the flat end-cavity mirrors of the DPRA is replaced by a volume Bragg grating (VBG) 210. The VBG 210 that was used is a bulk piece of photothermorefractive glass, where a grating is permanently written by UV illumination followed by thermal development. The VBG has a bandwidth of 230 pm (FWHM) centered at ˜1053 nm. With solgel antireflection coating, the VBG had a single-pass reflectivity of 99.4% at 1053 nm. Further details may be found in L. B. Glebov, V. I. Smimov, C. M. Stickley, and I. V. Ciapurin, Proc. SPIE 4724, 101 (2002) and A. V. Okishev, C. Dorrer, V. I. Smirnov, L. B. Glebov, and J. D. Zuegel, Opt. Express 15, 8197 (2007).

In the set-up shown in FIG. 2, the injected signal beam 208 is reflected once per round trip by the VBG. Spectral filtering in a regenerative amplifier cavity benefits from the large number of passes on the filtering element. Assuming a single-pass filtering spectral transmission T(ω), the spectral filter after N round-trips in the cavity is T(ω)^{N}, (T(ω)^{2N} if the filter is seen twice per round-trip).

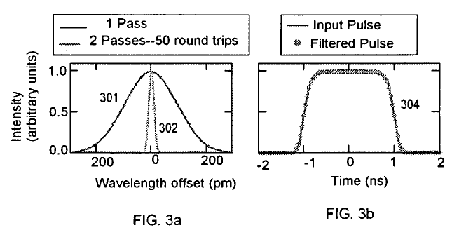

FIG. 3(a) shows the spectral reflection of a Gaussian filter 301 with a 230 pm (FWHM) bandwidth centered at 1053 nm, and the spectral reflection 302 after 50 round-trips in a cavity with two passes on the filter per roundtrip (or equivalently, after 100 round-trips in a cavity with one reflection per roundtrip on the filter). The effective filtering function has a bandwidth of 23 pm (FWHM) as shown by curve 302. Filtering of the ASE may advantageously be performed as long as the bandwidth reduction in the amplifier does not degrade the temporal shape of the output pulse. FIG. 3(b) shows a simulation of a 2 ns (FWHM) 20^{th} order super-Gaussian pulse before and after filtering by a 23 pm (FWHM) filtering function. A 2 ns FWHM pulse duration corresponds to the typical pulse widths used to pump OPCPA systems. No significant change in the temporal intensity was observed, indicating that an even narrower filter could be used. While different round-trips in the cavity correspond to a different effective bandwidth of the filter, ASE is mostly expected from the source seeding the regenerative amplifier and the first few round-trips in the amplifier (when the pulse energy is low), which correspond to the narrowest effective filtering function.

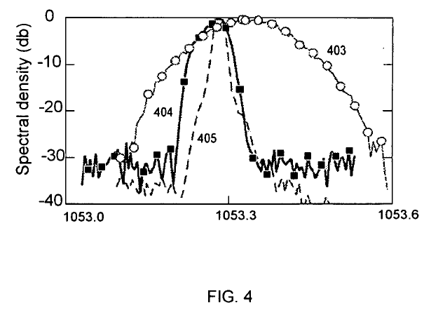

FIG. 4 shows the optical spectrum 403 of the unseeded DPRA measured with a mirror in the cavity in place of a spectral filter, indicating the broadband (146 pm) ASE; the optical spectrum 404 of the unseeded DPRA measured with the VBG in the cavity, having a reduced bandwidth of 41 pm; and the optical spectrum of the signal 405 amplified by the DPRA (limited by the resolution of the optical spectrum analyzer), which is significantly narrower than the spectrum 404 of the unseeded DPRA with the intracavity VBG. As shown, the bandwidth of spectrum 404 is broad enough to amplify the pump pulse without distortion.

Referring back to FIG. 1, subsequent pump amplification to 2 J is accomplished by four passes in a crystal large-aperture ring amplifier (CLARA) 106 containing two flash-lamp-pumped Nd:YLF rods, after apodization of the DPRA beam. Frequency conversion to 526.5 nm occurs in an 11 mm lithium triborate (LBO) crystal 108 with an efficiency of 70%. Filtering in the DPRA decreases the amount of ASE from the IFES 102 and from the DPRA 104 itself, which is particularly advantageous since these two high-gain stages have the largest contribution to the pump ASE.

With further reference to FIG. 1, the OPCPA system 110 is composed of a mode-locked laser 112 operating at 1053 nm, an Öffner-triplet stretcher 113 providing a dispersion of 300 ps/nm, a preamplifier 114 with two 29.75 mm LBO crystals in a walkoff compensating geometry, a power amplifier 115 with one 16.5 mm LBO crystal, and a two-grating compressor 116 in a double-pass configuration. The pump pulse is split to pump the preamplifier and power amplifier. The signal is amplified to 250 mJ and a portion of the amplified pulse is sent to the compressor. The temporal contrast was measured using a scanning third-order cross correlator 117 (Sequoia, Amplitude Technologies). The dynamic range of the experimental diagnostics is 10¹¹ but was limited to 10⁸ by the parametric fluorescence from the OPCPA system.

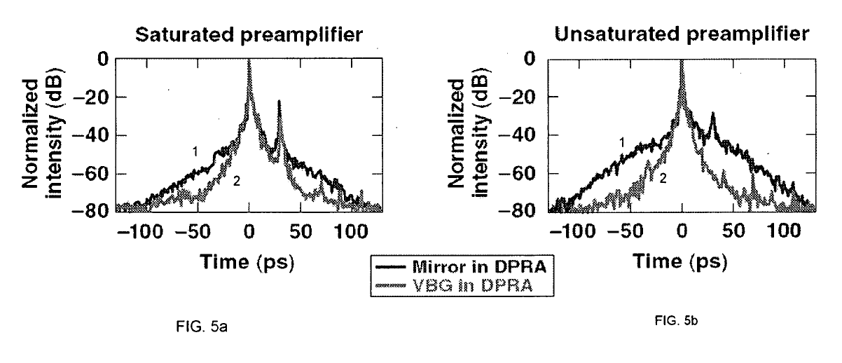

FIG. 5a shows the third-order scanning cross correlation of the OPCPA output pulse when only the preamplifier is running at saturation, and, in FIG. 5b when only the preamplifier is running at half its nominal output power (unsaturated amplifier). In each case, the cross correlation measured with the mirror in the DPRA is plotted with a continuous curve (1) and the cross correlation measured with the VBG in the DPRA is plotted with a dashed curve (2). As can be seen, the prepulse contrast is consistently improved with the intracavity VBG. The pump-induced contrast degradation is particularly important in the preamplifier, even when it is run at saturation, and a contrast improvement of the order of 20 dB is observed. When the preamplifier is run at half output power, a larger coupling between the pump intensity and the amplified signal intensity magnifies the impact of the pump noise on the contrast. The choice of the crystals and pump intensities in this system reduces the spatial intensity modulations in the amplified signal. This decreases the temporal intensity modulations in the amplified signal and reduces the impact of the pump intensity variations on the contrast of the recompressed pulse. Since OPCPA systems typically are not designed with these considerations in mind, the contrast improvement is expected to be significant for these systems.

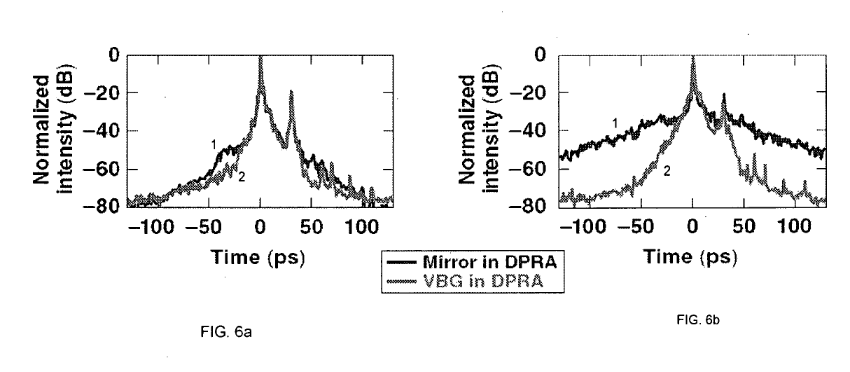

The optical signal-to-noise ratio (OSNR) of the OPCPA pump pulse was reduced by decreasing the average power of the monochromatic source in the IFES from its nominal value of 10 mW to 0.1 mW and compensating the reduced output energy by increasing the DPRA diode pump current. The reduced OSNR is due to the reduced seed level in both the IFES fiber amplifier and the DPRA. FIG. 6a shows the third-order scanning cross correlation of the OPCPA output pulse measured when the preamplifier and power amplifier are operated at the nominal value of 10 mW. FIG. 6b shows the third-order scanning cross correlation of the OPCPA output pulse measured when the average power of the monochromatic laser of the IFES is reduced from 10 mW to 0.1 mW. The cross correlation measured with the mirror in the DPRA is plotted with a continuous curve (1) and the cross correlation measured with the VBG in the DPRA is plotted with a dashed curve (2). The reduced power of the IFES laser leads to a significant increase in the ASE content of the amplifier pump pulse, which induces a significant contrast degradation on the signal pulse, as can be seen by comparing the curves (1) of FIGS. 6a and 6b, which correspond to an unfiltered pump pulse. With the VBG in the DPRA, the temporal contrast is not impacted by the increase in the ASE content of the pump pulse, as shown by the curves (2) in FIGS. 6a and 6b for a VBG in the regenerative cavity.

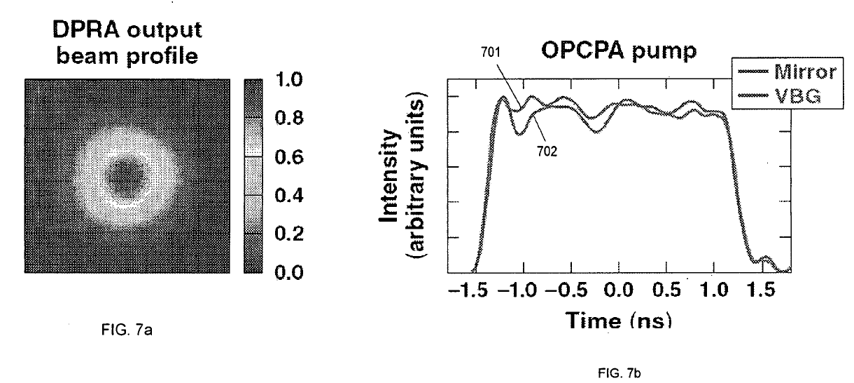

FIGS. 7a, 7b are presented to demonstrate that there is no significant impact of the VBG on the spatial and temporal properties of the pump pulse that could preclude its use to pump the OPCPA system. FIG. 7(a) shows the measured beam profile of the DPRA with an intracavity VBG. The beam profile corresponds to what is expected from this amplifier, and does not show any degradation due to the VBG. FIG. 7(b) presents a comparison of the temporal intensity of the pump pulse used to pump the OPCPA system with and without a VBG in DPRA. Curve 701 corresponds to the intensity with a mirror in the DPRA, and curve 702 corresponds to the intensity with a VBG in the DPRA. The two intensities correspond to a high-order supergaussian pulse shape, and there is in particular no degradation of the fast leading and falling edge of the pulse.

Thus the illustrated embodiment demonstrates a simple technique to significantly improve the contrast of OPCPA systems by reducing the bandwidth of the fluorescence present on the pump pulse using a VBG in a regenerative cavity. Regenerative spectral filtering as disclosed herein is easily applicable to most OPCPA architectures.

As disclosed above, and as would be appreciated by a person skilled in the art, various types of filters may be utilized to improve the temporal contrast of OPCPA systems by spectral filtering of out-of-band ASE. It will be further recognized that these various filter types need not be disposed within the regenerative cavity; however, intracavity filtering provides an enhanced narrowing of the effective filter bandwidth generally on the order of the square root of the number of cavity round trips. Use of a VBG in the regenerative pump cavity provided a particularly advantageous solution to the problems recognized in the art.

While specific embodiments of the present invention have been described herein, it will be appreciated by those skilled in the art that many equivalents, modifications, substitutions, and variations may be made thereto without departing from the spirit and scope of the invention as defined in the appended claims.

We claim:

1. A method for improving the contrast of an optical parametric chirped pulse amplification system that uses a pump pulse to amplify an optical signal, comprising:
spectrally filtering the pump pulse within the optical parametric chirped pulse amplification system prior to its interaction with the optical signal.

2. The method of claim 1, wherein spectrally filtering the pump pulse comprises filtering out at least a portion of an amplified spontaneous emission of the pump pulse.

3. The method of claim 1, further comprising spectrally filtering the pump pulse during an amplification stage the pump pulse.

4. The method of claim 1, further comprising spectrally filtering the pump pulse after an amplification stage of the pump pulse.

5. The method of claim 1, further comprising spectrally filtering the pump pulse in a regenerative cavity amplifier component of the optical parametric chirped pulse amplification system.

6. The method of claim 1, comprising providing a pump pulse-amplified spontaneous emission spectral filter intermediate in an amplifier stage of the optical parametric chirped pulse amplification system.

7. The method of claim 1, comprising providing a volume Bragg grating for spectrally filtering the pump pulse.

8. The method of claim 7, comprising providing the volume Bragg grating as an end cavity reflector in a pump pulse amplifier component of the optical parametric chirped pulse amplification system.

9. The method of claim 8, comprising making multiple passes of the pump pulse on the volume Bragg grating prior to outcoupling the amplified pump pulse.

10. The method of claim 1, comprising spectrally filtering the pump pulse with at least one of a Fiber Bragg grating, a Fabry-Perot etalon, a dielectric mirror, a dielectric filter, and a dispersion-based filter.

11. The method of claim 1, further comprising spectrally filtering the pump signal while operating the optical parametric chirped pulse amplifier in a gain saturation regime.

12. An optical parametric chirped pulse amplification system, comprising:
a pump pulse source that generates a pump pulse;
a pump pulse amplifier that generates an amplified pump pulse;
an optical signal source that generates an optical signal to be amplified;
an optical signal amplifier that further includes an optical signal pulse stretcher and an optical signal pulse compressor; and
a spectral filter disposed in the system in a location to intercept the pump pulse prior to a combination of the pump pulse and the optical signal to be amplified.

13. The optical parametric chirped pulse amplification system of claim 12, comprising a plurality of spectral filters.

14. The optical parametric chirped pulse amplification system of claim 12, wherein the spectral filter is a volume Bragg grating.

15. The optical parametric chirped pulse amplification system of claim 12, wherein the pump pulse amplifier includes a regenerative cavity amplifier, further wherein the volume Bragg grating is disposed in the regenerative cavity.

16. The optical parametric chirped pulse amplification system of claim 15, wherein the volume Bragg grating is an end reflector in the regenerative cavity.

17. The optical parametric chirped pulse amplification system of claim 12, wherein the spectral filter comprises at least one of a Fiber Bragg grating, a Fabry-Perot etalon, a dielectric mirror, a dielectric filter, and a dispersion-based filter.
